(19) United States
(12) Patent Application Publication
(10) Pub. No.: US 2004/0243289 A1
(43) Pub. Date: Dec. 2, 2004

(54) Method and system of managing service reminders using mileage estimates

(76) Inventors: John Kelly, Hudson, OH (US); John Supra, Redondo Beach, CA (US)

Correspondence Address: Sean M. Fitzgerald, 3182 Campus Drive #342, San Mateo, CA, 94402-3123, US

(21) Appl. No.: 10/858,879

(22) Filed: Jun. 1, 2004

Related U.S. Application Data
(63) Continuation of application No. 60/475,408, filed on Jun. 2, 2003.

(51) Int. Cl. G06F 19/00

(52) U.S. Cl. 701/30; 701/29

(57) ABSTRACT

The present invention provides a method and system for generating and sending service reminders based on the estimated mileage the vehicle. The mileage of the vehicle can be estimated based on the age of the vehicle, or it can be based on the last known mileage of the vehicle and estimating the additional mileage using average vehicle mileage statistics. The mileage of the vehicle may be estimated based on actual vehicle history, and may be adjusted based on the characteristics of the vehicle, the driver, or the geographic location of the vehicle.

### RELATED APPLICATION DATA

This patent application claims priority to U.S. Provisional Patent Application No. 60/475,408, filed Jun. 2, 2003, which is hereby incorporated by reference.

### BACKGROUND

1. Field of the Invention

The field of the invention relates generally to systems for maintaining and managing customer relationships. More particularly, the present invention relates to the field of providing timely reminders for customers scheduling service appointments.

2. Related Background

The ability to generate repeat customer visits is a key aspect in the ability of a service shop to remain in business and increase profitability. Existing systems and methods of generating promotions typically rely on a vehicle's age, or elapsed time from a prior service visit, to send a service reminder or promotion. Often, service reminders are sent at regular time intervals, for example sending an oil change reminder every three months. The hope with such systems is that a reminder for a service reminder, for example a 30,000 mile brake inspection, will be received when the vehicle has around 30,000 mile on the odometer. Given the wide variance in the number of miles a particular vehicle may be driven in a given time, such reminders often arrive well outside of the desired range—thereby decreasing the chances the vehicle owner will respond to the service reminder by scheduling a service visit.

Accordingly, a need exists to provide timely and relevant reminders for automobile service.

### BRIEF DESCRIPTION OF THE FIGURES

FIG. 1 is a generalized block diagram of a computer system that may be used to implement the present invention.

FIG. 2 is a generalized block diagram of a server computer that may be used to implement the present invention

FIG. 3 is a flow diagram illustrating the process of updating vehicle mileage and generating service reminders, in accordance with the present invention.

FIG. 4 is a flow diagram illustrating the process of updating vehicle mileage, in accordance with the present invention.

FIG. 5 is a flow diagram illustrating an alternative process of updating vehicle mileage, in accordance with the present invention.

FIG. 6 is a flow diagram illustrating an alternative process of updating vehicle mileage, in accordance with the present invention.

FIG. 7 illustrates an example e-mail service bulletin reminder, in accordance with the present invention.

### SUMMARY

The present invention provides for a computer based system and method for generating reminders for mileage dependent servicing of vehicles. According to one aspect of the invention, a service reminder is generated by estimating a vehicles mileage and determining whether the estimated mileage falls within a relevant service window, and sending the service reminder if the mileage falls within the relevant service window. According to another aspect of the invention, the estimation of the vehicles mileage is calculated using average vehicle mileage statistics and the last know mileage of the vehicle. According to another aspect of the present invention, estimation of the vehicle's mileage is calculated using average vehicle mileage statistics and the age of the vehicle.

### DETAILED DESCRIPTION

The present invention is described in the context of a specific embodiment. This is done to facilitate the understanding of the features and principles of the present invention and the present invention is not limited to this embodiment. In particular, the present invention is described in the context of a mileage-based service bulletin reminder for an automobile.

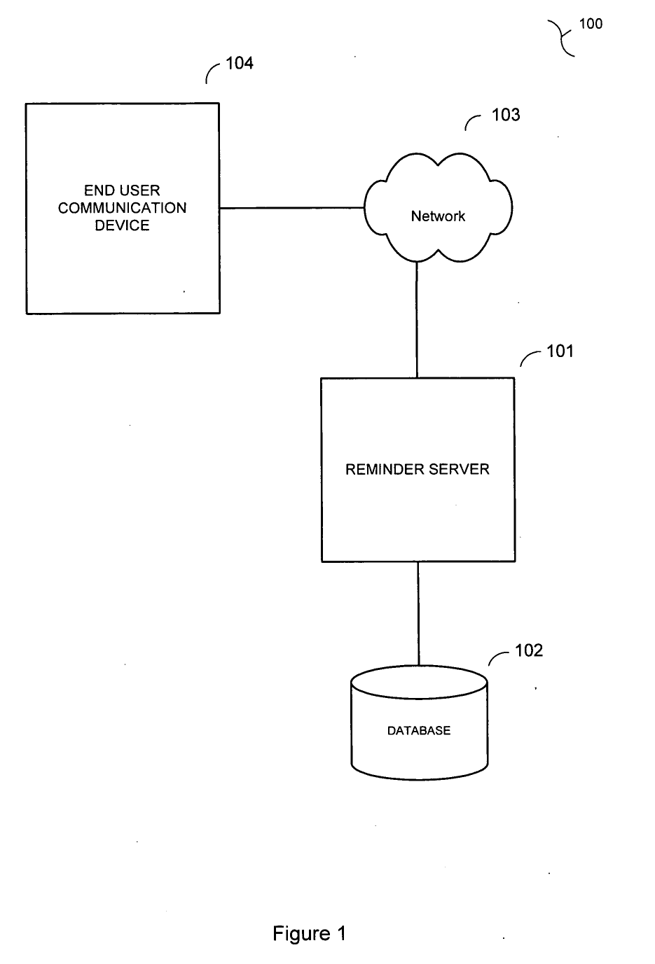

FIG. 1 is a block diagram of a computer system 100 that may be used to implement embodiments of the present invention. Computer system 100 includes a reminder server 101, connected to a database server 102 and a communications network 103. The communications network is connected to an end user communications device 104. In the presently preferred embodiment, the end-user communications device is a personal computer, connected to the internet, and capable of receiving either e-mail, web based e-mail, or instant messenger (IM) messages. Connection to the Internet could be by any form of Internet connection, including broadband and wireless connection. Alternatively, the end user communications device could be a mobile phone (including mobile phones with text messaging capabilities), standard telephone, or any other device capable of receiving text of voice messages.

While the presently preferred embodiment utilizes a database server 102 as a separate server from the reminder server 101, alternate embodiments could have the database run on the same computer as the reminder server. Additionally, the information stored within the singe database of the presently preferred embodiment could be distributed among several databases in alternative embodiments.

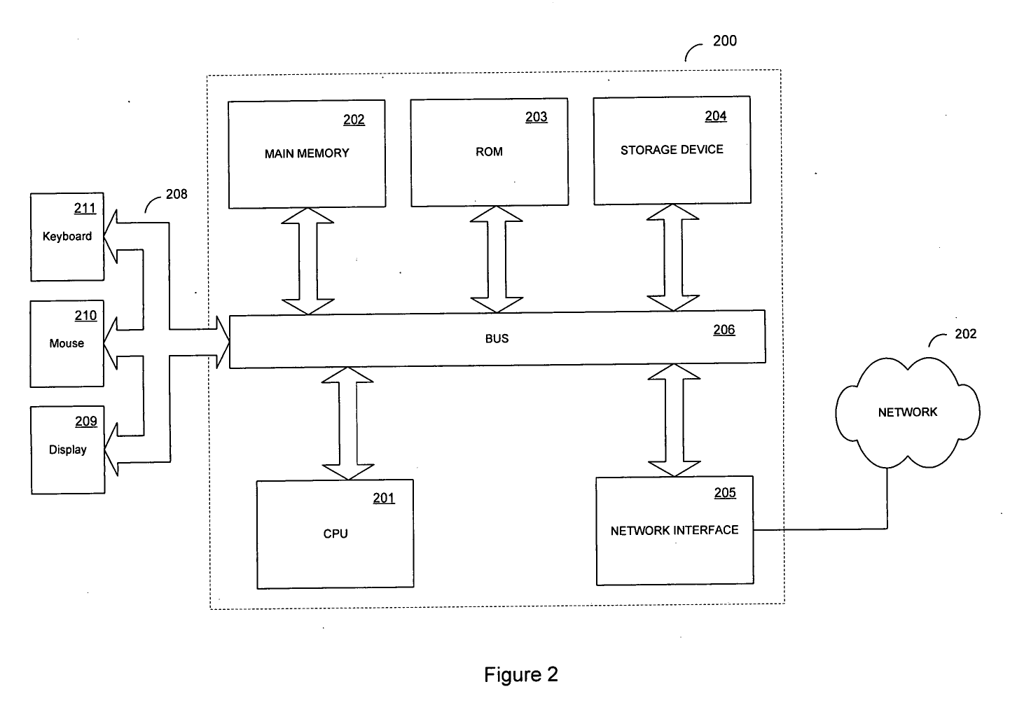

The reminder server is similar in general architecture to the database server and end user communication device. FIG. 2 is a generalized block diagram of a server computer 200 including a central processing unit (CPU) 201, main memory (typically RAM) 202, read-only memory (ROM) 203, a storage device (typically a hard drive) 204, and a network device (typically a network interface card, a.k.a. NIC) 205. The server includes a bus 206 or other communication mechanism for communicating information between the CPU 201 coupled with bus 206. The CPU 201 is used for processing instructions and data. The main memory 202, ROM 203 and storage device 204 are coupled to bus 206 and store information and instructions to be executed by processor 201. Main memory 202 also may be used for storing temporary variables or other intermediate information during execution of instructions to be executed by processor 201.

Server 200 may be coupled via bus 208 to a display 209, such as a cathode ray tube (CRT) or flat panel monitor, for displaying information to a computer user. An input device 210, such as a keyboard, is coupled to bus 208 for entering information and instructions to the server 200. Additionally, a user input device 211 such as a mouse, a trackball, or cursor direction keys for communicating direction information and command selections to the processor 201 and for controlling cursor movement on the display 209 may be used with the server 200.

The server 200 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 201 for execution. Such a medium may take many forms including, but not limited to, non-volatile media, volatile media, and transmission media. Examples of non-volatile media include, for example, optical or magnetic disks, such as storage device 204. Examples of volatile media include dynamic memory, such as main memory 202. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 206 and 208. Transmission media can also take the form of acoustic, electromagnetic or light waves, such as those generated during radio-wave and infra-red data communications.

### Updating Mileage and Generating Service Reminders

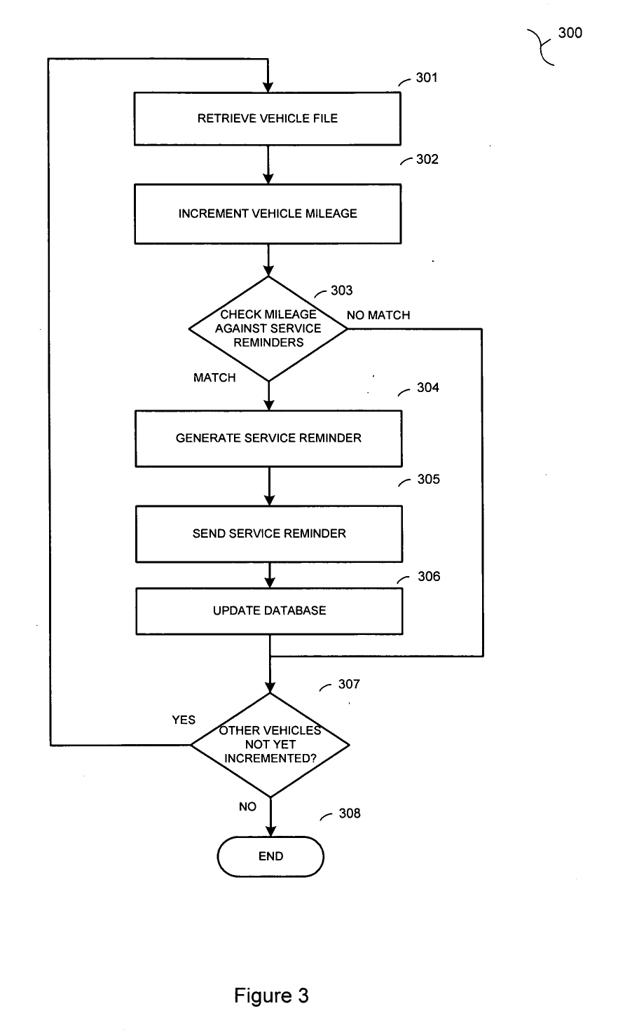

FIG. 3 is a flow diagram illustrating the process 300 of updating vehicle mileage and generating service reminders. As used herein, the term vehicle refers to any vehicle which may require servicing based upon the distance traveled, including, without limitation, automobiles, light trucks, SUVs, motorcycles, heavy trucks, construction or farm equipment, trains, boats, bicycles, etc. The term mileage, as used herein, is used generally to refer to the measured distance the vehicle has traveled, which could be measured in units of miles, kilometers, hours operated, or any other unit of distance corresponding to wear and tear on the vehicle. At step 301 the system retrieves vehicle information from the database 102. In the presently preferred embodiment vehicle information retrieved includes the make and model of the vehicle, the age of the vehicle, the most recent known mileage of the vehicle (if available), service history (if any), a unique identifier for the vehicle, and information regarding the owner of the vehicle such as the owner's name and contact information. Additionally, data regarding past service reminders, including the most recent service reminders, could also be retrieved at step 301. At step 302 the system updates the mileage of the vehicle to create an estimate of the current mileage of the vehicle. After updating the current mileage estimate of the vehicle at step 302, the system proceeds to step 303 to determine whether there is a mileage-based service reminder corresponding to the vehicle using the updated mileage estimate.

Service reminders can be based on several criteria, such as the mileage of the vehicle, the age of the vehicle, the season, or other factors which may impact the need for servicing the vehicle. One possible example of a mileage based service bulletin would be for a 30,000 mile brake check. A service reminder window for this brake check service reminder is 27,000 miles to 33,000 miles. Thus, the system would send a service reminder to the owner of a vehicle having a current mileage estimate between 27,000 miles and 30,000 miles.

While most mileage specific service reminders will be based on a total mileage of the vehicle, the present invention allows for mileage specific service reminders that are either mileage additive or mileage specific to a component of the vehicle. A mileage additive service reminder allows for a reminder to be sent when the vehicle has put an additional present mileage on the vehicle. For example, a service technician could, after noticing the break wear on the vehicle, enter a reminder into the system to be sent a brake service reminder when the vehicle is estimated to have an additional 5,000 miles on the odometer. The component mileage reminder is allows the accumulated mileage of a specific component of the vehicle to trigger the sending of a service reminder. For example, a truck where the transmission was replaced at 120,000 miles may be set for a 50,000 miles service to the replaced transmission. As the vehicle itself has over 50 k miles on its odometer, the present invention allows for the estimation of mileage on specific components based upon service history (the date and nature of the service, as well as the recorded or estimated mileage at the service interval). If the replacement part is not new, the system can account for mileage the replacement part had on it prior to installation in estimating the mileage on the replacement part, or the system can schedule replacement parts for more frequent service—as may be necessary when there is no reliable estimate for the mileage on a used or refurbished replacement part.

At step 303 the system compares the current mileage estimate from step 302 against a list of mileage-based service reminders with mileage based reminder windows. Information regarding the service reminders is stored in the database 102 and can be retrieved either at step 301 or at step 303. The information regarding a service bulletin reminder retrieved from the database includes an identifier (or name) identifying the service bulletin reminder, vehicle make and model information (if the service reminder is make or model specific), vehicle mileage window information, and seasonal or date information (if the service reminder is specific to a particular season or seasons, or has a particular date information associated with it). Additionally, other details of the vehicle can be compared to the criteria of the service reminder to determine whether the service reminder is appropriate for that vehicle. Examples of other details include the vehicle's transmission type (automatic or manual), engine type, option packages, modifications or prior service history, whether the vehicle typically experiences normal, severe or unusual driving conditions (for example, towing a heavy trailer or a high degree of stop and go traffic, or with a shuttle bus, may rate a “severe” driving condition criteria whereby the vehicle will qualify for different maintenance or at different maintenance intervals) or any other aspects that can influence the type of service appropriate for the vehicle. The system compares the vehicle information to the service bulletin reminders to check if there is a matching service reminder for that vehicle and where the vehicles current mileage estimate is within the service window for the service bulletin reminder. Additionally, at step 303 the system checks that seasonal or date information for the service bulletin also matches the current season or date. The system can also screen the reminder against previously sent reminders to prevent duplication or excessive notices, for example by checking whether a particular reminder has already been sent for the particular service bulletin. If at step 303 one or more of the service bulletins matches the information for the vehicle then the system proceeds to step 304. If none of the service bulletins match the vehicle's attributes, then the system proceeds to step 307.

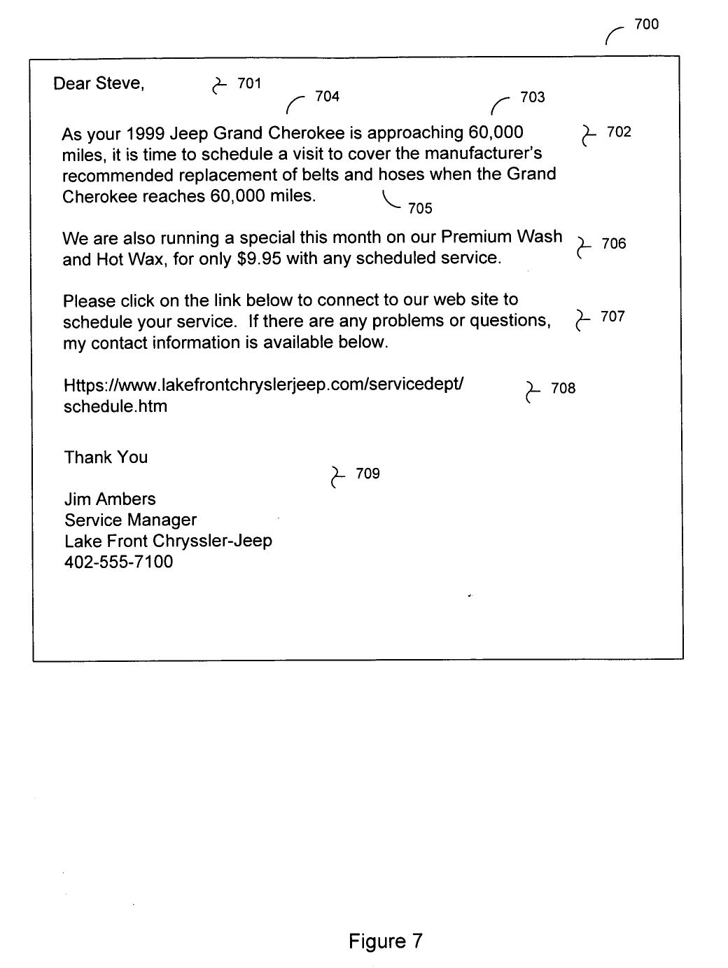

At step 304 the system generates a service bulletin reminder based on the vehicle's information, including the name and contact information of the vehicle's owner, as well as information pertaining to the service bulletin, including the name of the service identifier and mileage information. The type of reminder generated, for example an e-mail, regular postal mail, or a voice mail, can be based upon the contact information of the vehicle's owner (or primary contact regarding servicing the vehicle) or preference information regarding the preferred method of sending the reminder. An example e-mail service bulletin reminder is described below in connection with FIG. 7. After generating the service bulletin reminder at step 304 the system proceeds to step 305.

At step 305 the system sends the service bulletin reminder (according to the preferred method of transmitting the reminder) to an identified recipient (typically the vehicle's owner, or another person responsible for maintenance and servicing of the vehicle). The timing of sending the service bulletin reminder can be controlled depending on multiple factors. The system can send multiple reminders at a specific time or time frame, for example to suit other factors such as network bandwidth constraints, etc. Alternatively, the reminder can be sent at a time must appropriate to be received, as with a voice mail reminder. After the reminder has been sent at step 305 the system proceeds to step 306.

At step 306 the system updates the database to include information regarding the reminder just sent. The vehicle information data is updated to include the identifier of the sent service bulletin reminder, the date and time the service bulletin was sent, the mileage of the vehicle on the date the reminder was sent, the address the reminder was sent to (e-mail address, physical address, IM user ID, phone number, etc.) and the method of sending the reminder (e-mail, postal mail, voice message, IM message, etc.).

After updating the database at step 306 the system proceeds to step 307 where it determines whether there are other vehicles in the database scheduled for updating and service bulletin reminder screening. In the presently preferred embodiment, the system updates the mileage of all the vehicles in the database and checks for matching service bulletins on a daily basis. More particularly, the present invention performs updates and checks each night, and sends out service bulletin e-mail reminders at night. Alternate embodiments of the present invention could perform updating and checking at other intervals, and could schedule reminder notices at times most appropriate to the method of sending the reminder. Additionally, the system could process a portion of all the vehicles in the database by scheduling only a subset of all vehicles in the database for updating and reminder screening. If at step 307 the system determines that all vehicles to be updated and screened for reminders have been updated and screened, then the system proceeds to step 308 and ends the updating and screening process. However, if at step 307 the system determines that it has not yet completed all vehicles scheduled to be updated and screened, the system then proceeds to step 301 where it retrieves vehicle information for a vehicle which has yet to be updated and screened. Accordingly, the system proceeds until it has completed all vehicles that are to be updated and screened for service bulletin reminders.

### Estimating Vehicle Mileage

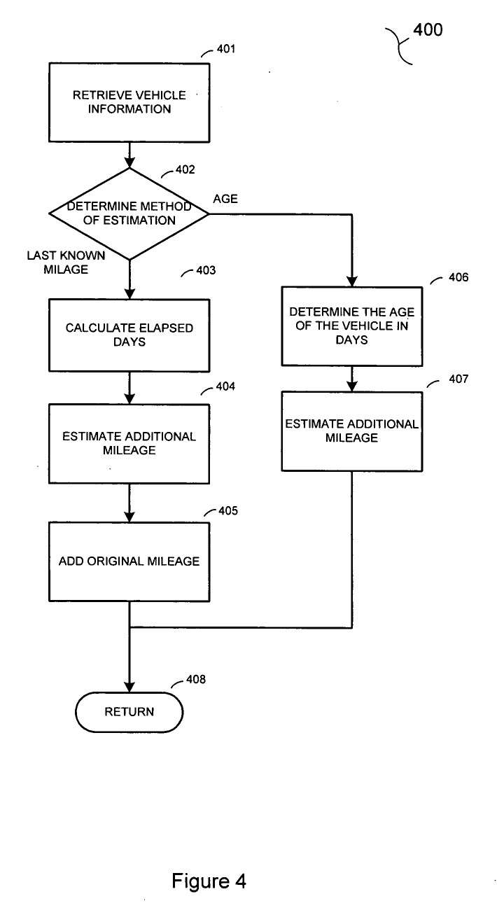

FIG. 4 illustrates one process 400 of updating the vehicle's mileage. At step 401 the system retrieves information from the database on the vehicle's mileage. This information includes the last known mileage of the vehicle (if available), the date the last known mileage was recorded, the age of the vehicle, and the preferred method of estimating the vehicles mileage. After step 401 the system proceeds to step 402 to determine which method of estimating the vehicle's current mileage is to be used. At step 402 the system checks to see if there the information retrieved at step 401 includes data specifying which method is to be used. If the information indicates the vehicle's age should be used, then the system proceeds to step 407. If the information indicates the vehicle's last known mileage should be used and updated, then the system proceeds to step 403.

In the presently preferred embodiment the database includes information which specifies which process of updating the vehicle's mileage should be used. Alternative embodiments of the present invention could use the existence of the vehicle's last known mileage to determine how a current mileage estimate is calculated. For example, if at step 402 there is no value, or a zero value, for the vehicle's last known mileage, the system proceeds to step 407. If at step 402 there is a last known mileage, or a non-zero mileage for the vehicle, the system proceeds to step 403. Ideally, the last known Mileage would be a mileage taken from a reading of the vehicle's odometer. However, estimates or other information may be used if an actual reading of the odometer is not available.

At step 403 the system determines the number of days elapsed since the last known mileage of the vehicle was determined. While in the presently preferred embodiment the last known mileage would represent an actual reading of the vehicle's odometer, alternative embodiments could use an estimated value as the vehicle's last known mileage. At step 404 the system determines an estimate of additional mileage put on the vehicle according to Equation 1 where:

Additional Mileage=(days elapsed)×(avg. daily mileage) Eqn. 1

The system then proceeds to step 405, where the vehicle's current mileage is estimated using Equation 2, where:

Current Mileage=Additional Mileage+Last Known Mileage Eqn. 2

The system then proceeds to step 408 and returns the estimate of the Current Mileage.

If after step 402 the system proceeds to step 406, at step 406 a calculation is made to determine the age of the vehicle in days based on information indicating the vehicle's age, for example the vehicle's registration date, purchase date, etc. The system then proceeds to step 407 where the Current Mileage is calculated based upon Equation 3:

Current Mileage=(age of the vehicle)×(avg. daily mileage) Eqn. 3

After step 407, the system then proceeds to step 408 and returns the estimate of the Current Mileage. In the presently, preferred embodiment, returning the estimate of the current mileage would also include storing the estimate in the database.

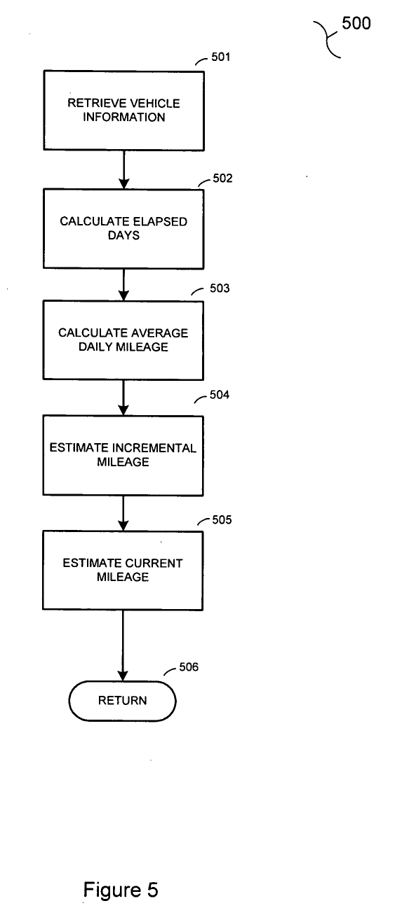

An alternate embodiment of the present invention is shown in FIG. 5, where the process 500 is used to estimate the vehicle's mileage based on the known mileage history of the particular vehicle. At step 501 the vehicle's information is retrieved from the database, including the mileage of the vehicle, the date the vehicle's mileage was recorded, the age of the vehicle, and any other information used in the estimate. At step 502 the system calculates the number of days elapsed since the date the vehicle's mileage was recorded. At step 503 the average daily mileage of the vehicle is calculated, according to equation 4:

avg. daily mileage=Mileage/(days elapsed) Eqn. 4

The mileage used in Equation 4 could be either to the total mileage of the vehicle, or it could be the incremental mileage between the last visit and a prior visit (or even between any two prior mileage readings). If the total mileage of the vehicle is used, the days elapsed used in Eqn. 4 will be the age of the vehicle in days. If the incremental mileage is used, then the days elapsed is the number of days between the to prior mileage readings, which in the presently preferred alternate embodiment is the two most recent prior service visits. As above, the mileage could be from an actual reading or another estimate. After calculating the average daily mileage for the particular vehicle at step 503, the system proceeds to step 504.

At step 504 an estimate of the incremental mileage is calculated with Equation 5:

Incremental Mileage=(days since last mileage recording)×(avg. daily mileage) Eqn. 5

After estimating the Incremental Mileage at step 504, at step 505 an estimate for the current mileage is performed using Equation 6:

Current Mileage=Incremental Mileage+Last Mileage Recording Eqn. 6

From step 505 process the system advances to step 506, where the estimate of the Current Mileage is returned.

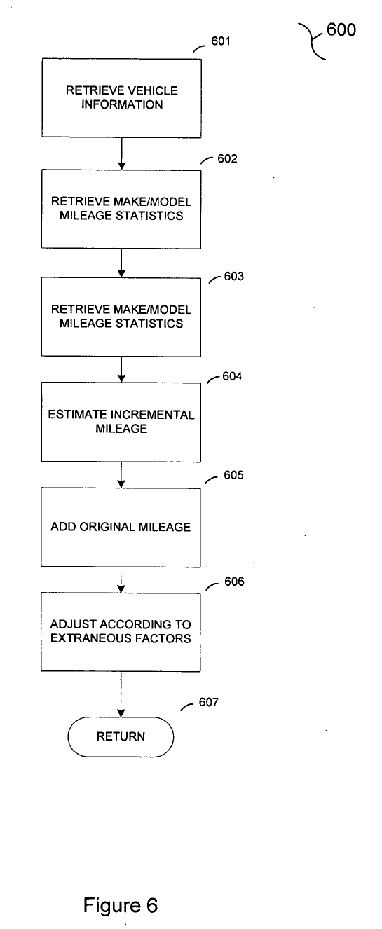

Referring now to FIG. 6, an alternate embodiment of the present invention is shown utilizing make and model information to estimate the vehicle's mileage. The process 600 begins at step 601 with the retrieval of vehicle information from the database. In addition to mileage information, the system also retrieves other information on the vehicle, such as the vehicles make, model, and model year. Additionally, the system could also retrieve information such as options the vehicle has (automatic transmission, four wheel drive, option group, dealer installed optional equipment, aftermarket installed optional equipment, etc.), information relating to service history (such as a rebuilt motor, replaced transmission, number of time the muffler has been replaced), geographic information relating to where the vehicle is mainly driven or garaged, driver or owner information (such as age, sex, marital status, occupation, income, hobbies, dependents, whether the vehicle is owned by an individual or a business, etc.) or other such information on the vehicle.

The system then proceeds to step 602 where it retrieves from the database vehicle mileage statistics. Vehicle mileage statistics provide average daily mileage information based upon information retrieved at step 601. From step 602 the system proceeds to step 603 where the number of days elapsed since the date the vehicle's mileage was recorded is retrieved from the database. In the event there has been no entry into the database of a recording of the vehicle's mileage, or in the event the date of the vehicle's mileage is uncertain, then the system will proceed using zero mileage for the vehicle and calculate the age of the vehicle in days.

At step 604 an estimate of the incremental mileage is calculated with Equation 7:

Incremental Mileage=(days since last mileage recording)×M^{vspec}_{avg} Eqn. 7

where M^{vspec}_{avg} is the average daily mileage for a specific vehicle. M^{vspec}_{avg} may also be dependent on the location of the vehicle, or any particular characteristics of the vehicle or the vehicle's owner/driver, as described above in the context of the information retrieved during steps 601 and 602.

After estimating the Incremental Mileage at step 604, at step 605 an estimate for the current mileage is performed using Equation 8:

Current Mileage=Incremental Mileage+Last Mileage Recording Eqn. 8

From step 605 the system advances to step 606, where the estimate of the Current Mileage is adjusted for extraneous factors according to one of two possible equations. Equation 9 is used in step 606 when the mileage is expected to differ by a given percent from the Current Mileage estimated with Eqn. 8, as is typical of extraneous factors such as seasonal variation, as when people may drive additional miles during the summer, or when a vehicle is used in a certain way, for example when a pickup truck is used primarily to tow a boat and is a second vehicle of the owner. The Revised Current Mileage is given by:

Revised Current Mileage=Current Mileage×Δ^{F} Eqn. 9

where Δ^{F} is the extraneous factor multiplier. The extraneous factor multiplier Δ^{F} can be greater than, or less than, one to accommodate increases or decreases in expected mileage.

Alternatively, at step 606 the system could use equation 10 to estimate the Revised Current Mileage:

Revised Current Mileage=Current Mileage+Π^{F} Eqn. 10

where Π^{F} is the extraneous factor adder, and can be either positive or negative. One possible example of an extraneous factor adder is if a given winter had a particularly harsh storm, making driving difficult or impossible for several days. In such an instance a negative extraneous factor adder could be used to account for a modest deviation from typical average daily driving totals. While the presently preferred alternative embodiment utilizes an adjustment for extraneous factors, any of the embodiments in the present invention could use an extraneous factor adjustment to account for variations in driving habits among different vehicles and drivers.

From step 606 the system advances to step 607, where the estimate of the Current Mileage is returned.

### Example Service Reminder

FIG. 7 illustrates an example service reminder message 700 generated by process 300 described in connection with FIG. 3. The reminder 700 is sent as an e-mail, and like a standard e-mail includes a greeting, or salutation, 701 and message body 702. The service reminder message body includes a mileage alert 703, a vehicle identifier 704, and at least one service reminder 705. In the example shown the mileage alert specifies the estimated current mileage of the vehicle (in this example 60,000 miles), or the mileage the vehicle is estimated to be approaching. As shown, the service reminder 705 is a mileage specific service reminder, identifying the belts and hoses as scheduled for inspection and replacement. The example service reminder message 700 also includes a service promotion 706, which is not mileage specific, e.g. a wash and wax service. Service reminders messages may include as many service reminders or service promotions as pertinent to the vehicle, and may include service reminders or service promotions to more than one vehicle if the recipient is responsible for the care and servicing of more than one vehicle. The message body 702 also includes scheduling instructions 707, which in the present example also includes a scheduling link 708 which is a hyperlink to a web site where the recipient can schedule service of the vehicle. In the presently preferred embodiment, the recipient of the service reminder message 700 (typically the owner of the vehicle, but possibly another person or specific address the message is sent to regarding care and maintenance of the vehicle) would click on the scheduling link, which would connect a browser on the recipients computer to the scheduling web site. Alternate embodiments of the present embodiment could have a phone number, IM address, or other identifying information as the scheduling link, providing the recipient with the ability to contact the service shop to schedule a service appointment. In addition to the greeting 701 and message body 702, the service reminder message 700 also includes a signature identifier 709, which may provide the recipient with a name and contact information for inquiries.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

1. A method of generating a service reminder for a vehicle, comprising:
retrieving information on a particular vehicle from a database,
estimating the current mileage of the particular vehicle using the mileage history of the vehicle, wherein the average daily mileage of the vehicle is calculated from the last known mileage of the vehicle, and the time elapsed since recording the last known mileage of the vehicle is multiplied by the calculated average daily mileage of the vehicle to estimate the vehicle's current mileage,
comparing the current mileage estimate to a list of service reminders, and
in the event the estimated current mileage matches a mileage window for a service reminder, generating a service reminder.

2. The method of claim 1 further comprising the step of sending the service reminder as an e-mail message to a recipient responsible for the care of the vehicle.

3. The method of claim 1 fuirther comprising the step of sending the service reminder vial postal mail to a recipient responsible for the care of the vehicle.

4. The method of claim 1 further comprising the step of sending the service reminder as voice message to a recipient responsible for the care of the vehicle.

5. The method of claim 1 further comprising the step of adjusting the estimated mileage by multiplying an extraneous factor multiplier.

6. The method of claim 1 further comprising the step of adjusting the estimated mileage by adding an extraneous factor adder.

7. A method of generating a service reminder for a vehicle, comprising:
retrieving information on a particular vehicle from a database,
determining the process of estimating the vehicle's mileage, then:
(i) in the event the determination indicates the vehicle age should be used,
estimating the current mileage of the particular vehicle using the age of the vehicle, wherein the age of the vehicle is multiplied by an average mileage per time period factor to estimate the vehicle's current mileage,
(ii) in the event the determination indicates the vehicle's last known mileage should be used,
estimating the current mileage of the particular vehicle using the mileage history of the vehicle, wherein the average daily mileage of the vehicle is calculated from the last known mileage of the vehicle, and the time elapsed since recording the last known mileage of the vehicle is multiplied by the calculated average daily mileage of the vehicle to estimate the vehicle's current mileage,
comparing the current mileage estimate to a list of service reminders, and
in the event the estimated current mileage matches a mileage window for a service reminder, generating a service reminder.

8. The method of claim 7, further comprising the step of sending the service reminder as an e-mail message to a recipient responsible for the care of the vehicle.

9. The method of claim 7, further comprising the step of sending the service reminder vial postal mail to a recipient responsible for the care of the vehicle.

10. The method of claim 7, further comprising the step of sending the service reminder as voice message to a recipient responsible for the care of the vehicle.

11. A computer-readable medium containing instructions for performing a method of protecting data in a computer system, the method comprising:
retrieving information on a particular vehicle from a database,
estimating the current mileage of the particular vehicle using the mileage history of the vehicle, wherein the average daily mileage of the vehicle is calculated from the last known mileage of the vehicle, and the time elapsed since recording the last known mileage of the vehicle is multiplied by the calculated average daily mileage of the vehicle to estimate the vehicle's current mileage,
comparing the current mileage estimate to a list of service reminders, and
in the event the estimated current mileage matches a mileage window for a service reminder, generating a service reminder.

12. The computer-readable medium of claim 11 wherein the method further comprises the step of sending the service reminder as an e-mail message to a recipient responsible for the care of the vehicle.

13. The method of claim 11 wherein the method further comprises the step of adjusting the estimated mileage by multiplying an extraneous factor multiplier.

14. The method of claim 11 wherein the method further comprises the step of adjusting the estimated mileage by adding an extraneous factor adder.
